(19) United States
(12) Patent Application Publication
(10) Pub. No.: US 2012/0235400 A1
(43) Pub. Date: Sep. 20, 2012

(54) Validation of Lottery Tickets

(76) Inventor: Lyle Scrymgeour, Oakbank (CA)

(21) Appl. No.: 13/408,559

(22) Filed: Feb. 29, 2012

Related U.S. Application Data
(60) Provisional application No. 61/452,234, filed on Mar. 14, 2011.

(51) Int. Cl. B42D 15/00; A63F 9/24

(52) U.S. Cl. 283/102; 463/17

(57) ABSTRACT

A prize of an instant win lottery ticket of the type including a substrate with a game area thereon including play indicia, of which at least part is covered by a removable scratchoff layer is validated by a barcode printed on the ticket which contains the information necessary to validate the prize. The bar code of a played ticket is read by a reading device by scanning the barcode with the reading device while contact between the reading device and the substrate at the barcode is not required. Data from the bar code is used to obtain information from a data base on the value of the prize associated with that ticket.

This application claims the benefit under 35 USC 119 (e) of Provisional Application 61/452,234 filed Mar. 14,2011.

This invention relates to an apparatus for validation of lottery tickets.

### BACKGROUND OF THE INVENTION

Validation of instant lottery tickets have evolved over the past 30 years as the industry has grown. In the early stages the validation process was a manual process in which a retailer or their staff would be required to enter a string of numbers, which were located either in a box separate from the game play information or in the same area as the game data.

The string of data was entered onto a lottery terminal, which then submitted the string of information to a central computer where the string of numbers would be compared to a listing of numbers provided by the ticket manufacturer. The list of numbers from the manufacturer was prepared following the manufacturing process. Upon completion of the run of tickets, the manufacturer would prepare a list of all of the winning tickets in a game and the validation information which was associated with each. This set of numbers was compared to the string of information received and if a match was present, then the central system would send a message back to the lottery terminal advising the retailer that the ticket was a winner.

This process was slow and involved a high chance for error because of the high volume of data which had to be entered. The next phase in the evolutionary process involved the placement of a barcode on the back of the ticket which contained part of the string of numbers in a machine readable form and the remaining digits were placed under the scratchoff layer. The validation process then consisted of a scan of the barcode and the manual entry of a very limited number of digits (3 or 4). This process continues to be utilized by some lotteries. The additional digits are known as a key.

There has however been a move towards keyless validation, that is where no “key” or additional manually entered digits are used since this eliminates the requirement for any manual entry of the data necessary to complete the validation process.

Currently there are several keyless validation processes, which utilize barcodes and for which patents have been granted. Of these patents, one was originally assigned to BABN which is now assigned to Scientific Games Inc (SGI), one to GTech and three, which are related are assigned to SGI as the original assignee. These patents are as follows:

SGI U.S. Pat. No. 6,308,991 (Royer) for a single Barcode under Scratchoff

GTech U.S. Pat. No. 7,311,599 (Knapp) for a Dual Barcode system in which one is located under scratchoff and the second is positioned on the back of the ticket.

SGI U.S. Pat. No. 6,736,324 (Behm) for a partially covered validation barcode.

SGI U.S. Pat. No. 7,322,529 (Behm) for a partially covered barcode with ticket checker and automated process to forward data to on-line system if ticket checker indicated a winner.

SGI U.S. Pat. No. 7,611,065 (Behm) utilizes dual barcodes on the front of which one is partially or fully covered while the second is uncovered.

Currently in the marketplace there are two keyless validation methods, which involve the use of a barcode located under a scratchoff layer. One of these is the method described in the Royer patent while the other is as described in the Knapp patent.

### SUMMARY OF THE INVENTION

According to one aspect of the invention there is provided an apparatus comprising:

a plurality of lottery tickets;

each lottery ticket comprising a substrate with a game area thereon including play indicia, of which at least part is covered by a removable scratchoff layer by which the player can remove the scratch-off layer to reveal the game data for playing the game by the player to reveal whether the ticket is a winning ticket of a prize and if so a value of the prize;

each lottery ticket having printed on the substrate thereof a barcode which contains the information necessary to validate the prize of a winning ticket, which bar code is covered by a scratch-off layer;

and a reading device arranged for scanning the barcode when the reading device and the barcode are brought into proximity with each other, the reading device being arranged such that contact between the reading device and the substrate at the barcode is not required.

Either the barcode is positioned in the same area as the game data and covered with a part of the same scratchoff layer or the barcode is positioned in a separate area from the game data with its own separate scratch-off layer.

According to a second aspect of the invention there is provided a method for validating a lottery ticket comprising:

providing a plurality of lottery tickets;

each lottery ticket comprising a substrate with a game area thereon including play indicia, of which at least part is covered by a removable scratchoff layer by which the player can remove the scratch-off layer to reveal the game data for playing the game by the player to reveal whether the ticket is a winning ticket of a prize and if so a value of the prize associated with the ticket;

each lottery ticket having printed on the substrate thereof a barcode which contains the information necessary to validate the prize of a winning ticket, which bar code is covered by a scratch-off layer;

reading the bar code with a reading device by scanning the barcode with the reading device and the barcode brought into proximity with each other, the reading device reading the bar code while contact between the reading device and the substrate at the barcode is not required;

and using a processor to use data from the bar code to obtain information from a data base on the value of the prize associated with that ticket.

The arrangement described herein therefore provides an alternative keyless validation method. This includes non-contact scanning of a barcode under Scratchoff.

In claim 1 (c) of the above patent, U.S. Pat. No. 6,308,991 (Royer), it states:

“said bar code, after removal of the scratchoff coating being readable by a reading device when placed in contact therewith by an agent of the printed document”.

Using the normal meaning of the word “contact” as used in “contact sports”, “electrical contacts”, etc, the authentication process as claimed requires the retailer to bring the side of the physical ticket, which includes the barcode, into a position where the ticket and more importantly the barcode, is placed directly against the barcode reader, that is in contact therewith.

The requirement to place the barcode in “contact” with the reading device does create limitations and potential problems for the retailer and/or clerks. Typically these limitations/problems would include the following:

Scratchoff tickets include a removable coating placed over the components of the ticket, which should remain hidden until removed during the course of play and redemption. The scratchoff coating is designed to fragment when scratched with a fingernail or other type of device. When the scratchoff is removed, the latex material is generally pushed to side. However there is always some residual scratchoff left on the ticket surface. There is a strong potential for contamination of the surface of the reader by the transfer of portions of residual scratchoff, when the ticket and reader are brought into contact with each other. This contamination impacts on the overall reader performance and could result in problems. If the information within the barcode is misread, it could result in inaccurate information being utilized to make the determination of the win/lose status of the ticket. Potentially a winning ticket might not be correctly validated and a customer could be potentially advised that the ticket did not win. Similarly if the barcode cannot be read, the customer and retailer are both frustrated by the inability to accurately determine the status of the ticket being presented for redemption. This frustration could result in lost sales for the retailer because the customer could take their unredeemed ticket to a different retailer for validation. In many cases winners of lower tier prizes utilize their winnings to purchase additional tickets rather than simply taking the money.

The validation process of the ticket takes a longer period of time. The retailer/clerk is required to bring the ticket into direct contact with the reader. This process does take some extra time to ensure that the ticket and barcode are in contact with each other and are then held in that position until such time as acknowledgement is provided by the system to indicate that the scan was successful. This delay could result in longer line-ups at the counter and possibility of aggravating customers who are typically travelling to another place, that is home, work, etc.

The need to bring the two components into contact with each other may result in limitations in the sizing of the code. Typically a 2D code, such as a PDF 417, can be configured in a variety of shapes, square, rectangle (horizontal/vertical), etc. In some cases the height of the reading area of the reader may be less than the preferred height of the code. This would require the ticket manufacturer to either have to reduce the height of the code, which would make it longer or it would require the retailer/clerk to maintain the contact as they slide the ticket across the reader window. Space on a lottery ticket is a critical factor. Instant scratchoff tickets are primarily sold on impulse. Ticket vendors and the lotteries work together to develop tickets which have high impact graphic designs, designed to attract the interest of a customer while they are performing another task at a retail counter—paying for gas, confectionary, etc. Restrictions in the shape of the barcode can impact on the design characteristics of a ticket and could potentially result in a decline in the sales potential of a particular design.

The requirement to provide for the ability of the retailer/clerk to bring the ticket and barcode into contact with the reader could place restrictions on the design of the reader itself as well as the assembly into which it is built.

The above are examples of the kinds of problems that can be attributed to the requirement to bring the barcode into contact with the reading device.

It is an advancement within the lottery industry to develop a method by which an instant scratchoff ticket could be validated using a reading device which does not require the need for the placement of the ticket and reader in contact with each other in order to complete the validation process.

Preferably the validation method could be done by bringing the ticket and barcode into proximity with each other but which does not require contact between the two. Preferably the reader will have a range of distances for example 3 to 6 inches within which the barcode can be placed relative to the reader, which would result in a successful scanning of the barcode and resulting validation.

This method of ticket validation would result in:

a reduction in the time required to complete the validation process thru simpler means of presenting the ticket to the device

elimination of the possible contamination of the reader by residual scratchoff

reduction in possible inaccuracy of the validation information being obtained from the barcode

reduction in the restrictions placed on the designs of the ticket and of the reading device

### BRIEF DESCRIPTION OF THE DRAWINGS

One embodiment of the invention will now be described in conjunction with the accompanying drawings in which:

FIG. 1 is a plan view of the ticket substrate of a plurality of lottery tickets.

FIG. 2 is a schematic illustration of a validation apparatus including one of the tickets of FIG. 1

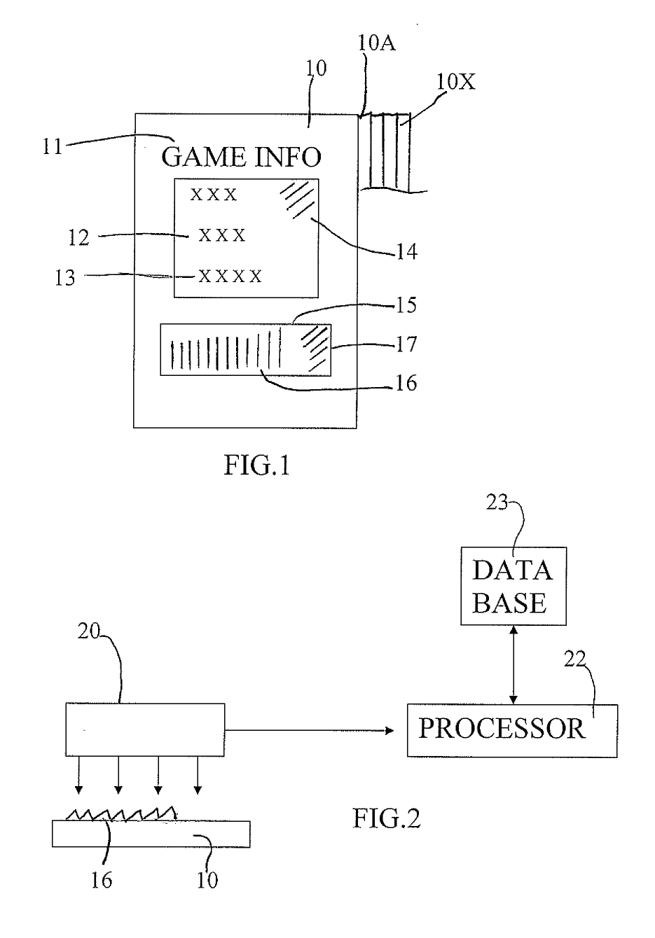

In the drawings like characters of reference indicate corresponding parts in the different figures.

### DETAILED DESCRIPTION

The apparatus of the present invention includes a plurality of lottery tickets 10 including tickets 10A to 10X.

Each lottery ticket is defined by a substrate with printed thereon various graphics and other information as indicated at 11 together with a game area 12 thereon including play indicia 13, of which at least part is covered by a removable scratchoff layer 14. This allows the player to remove the scratch-off layer to reveal the game data for playing the game by the player to reveal whether the ticket is a winning ticket of a prize and if so a value of the prize.

Each lottery ticket has printed on the substrate 10 thereof a barcode 16 in an area 15 which contains the information necessary to validate the prize of a winning ticket. The bar code is covered by a scratch-off layer 17.

The barcode is positioned either in the same area 12 as the game data and covered with a part of the same scratchoff layer 14 or positioned in a separate area 15 with its own scratch-off layer 17.

As shown in FIG. 2, a reading device 20 is arranged for scanning the barcode when the reading device 20 and the barcode 16 are brought into proximity with each other. The reading device is arranged such that contact between the reading device and the substrate at the barcode is not required, that is typically the reading device is spaced away from the ticket by a distance in the range 3 to 6 inches. The reading device includes software detecting the barcode from the reading system and communicates this to a processor 22 for determining the validation of the ticket and the amount of the prize. The processor is typically located at a retailer and communicates with a data base or look up table at the central lottery office as indicated at 23.

Typical readers can be of the following types:

Laser scanners use a laser beam as the light source and typically employ either a reciprocating mirror or a rotating prism to scan the laser beam back and forth across the bar code. A photodiode is used to measure the intensity of the light reflected back from the bar code. In both pen readers and laser scanners, the light emitted by the reader is rapidly varied in brightness with a data pattern and the photodiode receive circuitry is designed to detect only signals with the same modulated pattern.

CCD readers use an array of hundreds of tiny light sensors lined up in a row in the head of the reader. Each sensor measures the intensity of the light immediately in front of it. Each individual light sensor in the CCD reader is extremely small and because there are hundreds of sensors lined up in a row, a voltage pattern identical to the pattern in a bar code is generated in the reader by sequentially measuring the voltages across each sensor in the row. The important difference between a CCD reader and a laser scanner is that the CCD reader is measuring emitted ambient light from the bar code whereas laser scanners are measuring reflected light of a specific frequency originating from the scanner itself.

Camera-based readers use two-dimensional imaging scanners that provide the fourth and newest type of bar code reader. They use a camera and image processing techniques to decode the bar code.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. Apparatus comprising:
a plurality of lottery tickets;
each lottery ticket comprising a substrate with a game area thereon including play indicia, of which at least part is covered by a removable scratchoff layer by which the player can remove the scratch-off layer to reveal the game data for playing the game by the player to reveal whether the ticket is a winning ticket of a prize and if so a value of the prize;
each lottery ticket having printed on the substrate thereof a barcode which contains the information necessary to validate the prize of a winning ticket, which bar code is covered by a scratch-off layer;
and a reading device arranged for scanning the barcode when the reading device and the barcode are brought into proximity with each other, the reading device being arranged such that contact between the reading device and the substrate at the barcode is not required.

2. The apparatus according to claim 1 wherein the barcode is positioned in the same area as the game data and covered with a part of the same scratchoff layer.

3. The apparatus according to claim 1 wherein the barcode is positioned in a separate area from the game data with its own separate scratch-off layer.

4. A method for validating a lottery ticket comprising:
providing a plurality of lottery tickets;
each lottery ticket comprising a substrate with a game area thereon including play indicia, of which at least part is covered by a removable scratchoff layer by which the player can remove the scratch-off layer to reveal the game data for playing the game by the player to reveal whether the ticket is a winning ticket of a prize and if so a value of the prize associated with the ticket;
each lottery ticket having printed on the substrate thereof a barcode which contains the information necessary to validate the prize of a winning ticket, which bar code is covered by a scratch-off layer;
reading the bar code with a reading device by scanning the barcode with the reading device and the barcode brought into proximity with each other, the reading device reading the bar code while contact between the reading device and the substrate at the barcode is not required;
and using a processor to use data from the bar code to obtain information from a data base on the value of the prize associated with that ticket.

5. The apparatus according to claim 4 wherein the barcode is positioned in the same area as the game data and covered with a part of the same scratchoff layer.

6. The apparatus according to claim 4 wherein the barcode is positioned in a separate area from the game data with its own separate scratch-off layer
